(19) United States
(12) Patent Application Publication
(10) Pub. No.: US 2026/0094301 A1
(43) Pub. Date: Apr. 2, 2026

(54) EXTRINSIC CALIBRATION PARAMETER GENERATING DEVICE, SYSTEM, AND METHOD

(71) Applicant: HTC Corporation, Taoyuan City (TW)

(72) Inventor: Chao-Shuan HUANG, Taoyuan City (TW)

(21) Appl. No.: 19/178,891

(22) Filed: Apr. 15, 2025

Related U.S. Application Data
(60) Provisional application No. 63/634,434, filed on Apr. 15, 2024.

(51) Int. Cl. G06T 7/80; G06T 7/521; G06T 7/579; G06T 7/70

(52) U.S. Cl. CPC G06T 7/80; G06T 7/521; G06T 7/579; G06T 7/70

(57) ABSTRACT

An extrinsic calibration parameter generating device, system, and method are provided. Each of sensors of the device generates an observation data corresponding to a spatial point. A processor of the device calculates a spatial position of the spatial point indicated by each of the observation data based on the observation data of each of the sensors. The processor compares the spatial position indicated by each of the observation data to determine whether each of the observation data belongs to an outlier value or a normal value. In response to the observation data corresponding to a first sensor belonging to the outlier value, the processor generates an extrinsic calibration parameter corresponding to the first sensor based on the observation data of each of at least one second sensor.

### CROSS-REFERENCE TO RELATED APPLICATION

This application claims priority to US Provisional Application Serial Number 63/634,434, filed April 15, 2024, which is herein incorporated by reference in its entirety.

### BACKGROUND

### Field of Invention

The present invention relates to an extrinsic calibration parameter generating device, system, and method. More particularly, the present invention relates to an extrinsic calibration parameter generating device, system, and method that can correctly generate extrinsic calibration parameters.

### Description of Related Art

Users can perform pose tracking operations in a simultaneous localization and mapping (SLAM) system through an electronic device (e.g., a controller, a head-mounted display) equipped with a plurality of sensors (e.g., a sensor pair or a sensor array).

In the prior art, during the manufacturing process of an electronic device equipped with a plurality of sensors, calibration settings (e.g., position relationship, emitting parameters, spatial relationship parameters, etc.) are performed on the sensors to correctly perform subsequent conversion between two-dimensional images and three-dimensional space.

However, when the user uses the electronic device, the electronic device may cause an abnormal displacement of the position or direction of the sensor due to some reasons (e.g., collision impact occurs), which will cause the extrinsic parameters used by the electronic device to perform tracking operations to change.

Accordingly, if the extrinsic parameters of the electronic device are not calibrated, the electronic device will not be able to correctly perform data alignment operations when performing various operations (e.g., device positioning operations, object tracking), thereby reducing the user's service experience.

Accordingly, there is an urgent need for an extrinsic calibration parameter generating technology that can correctly generate extrinsic calibration parameters.

### SUMMARY

An objective of the present disclosure is to provide an extrinsic calibration parameter generating device. The extrinsic calibration parameter generating device comprises a plurality of sensors and a processor, and the processor is electrically connected to the plurality of sensors. Each of the plurality of sensors generates an observation data corresponding to a spatial point. The processor calculates a spatial position of the spatial point indicated by each of the observation data based on the observation data of each of the sensors. The processor compares the spatial position indicated by each of the observation data to determine whether each of the observation data belongs to an outlier value or a normal value. In response to the observation data corresponding to a first sensor belonging to the outlier value, the processor generates an extrinsic calibration parameter corresponding to the first sensor based on the observation data of each of at least one second sensor, wherein the observation data of each of the at least one second sensor belongs to the normal value.

Another objective of the present disclosure is to provide an extrinsic calibration parameter generating method, which is adapted for use in an electronic device. The extrinsic calibration parameter generating method comprises the following steps: receiving an observation data corresponding to a spatial point from each of a plurality of sensors; calculating a spatial position of the spatial point indicated by each of the observation data based on the observation data of each of the sensors; comparing the spatial position indicated by each of the observation data to determine whether each of the observation data belongs to an outlier value or a normal value; and in response to the observation data corresponding to a first sensor belonging to the outlier value, generating an extrinsic calibration parameter corresponding to the first sensor based on the observation data of each of at least one second sensor, wherein the observation data of each of the at least one second sensor belongs to the normal value.

Another objective of the present disclosure is to provide an extrinsic calibration parameter generating system. The extrinsic calibration parameter generating system comprises a plurality of electronic devices and a processing device, and the processing device is communicatively connected to the electronic devices. Each of the electronic devices comprises at least one sensor, and each of the at least one sensor generates an observation data corresponding to a spatial point. The processing device receives the observation data from each of the electronic devices. The processing device calculates based on the observation data, a spatial position of the spatial point indicated by each of the observation data. The processing device compares the spatial position indicated by each of the observation data to determine whether each of the observation data belongs to an outlier value or a normal value. In response to the observation data corresponding to a first sensor belonging to the outlier value, the processing device generates an extrinsic calibration parameter corresponding to the first sensor based on the observation data of each of at least one second sensor, wherein the observation data of each of the at least one second sensor belongs to the normal value.

The extrinsic calibration parameter generating technology (at least including the device, the system, and the method) provided by the present disclosure collects observation data corresponding to a spatial point generated by multiple sensors. Next, the observation data of the same environment from the sensors are compared to determine which observation data generated by the sensor is an outlier value (e.g., position offset may occur). Then, the extrinsic calibration parameters corresponding to the outlier sensor can be generated through the observation data generated by other non-outlier sensors in the environment, and the outlier sensor can be calibrated based on the extrinsic calibration parameters until the observation data generated by the outlier sensor is consistent with that of other sensors. In addition, the extrinsic calibration parameter generation technology provided by the present disclosure can be assisted in calibration by other electronic devices (e.g., controllers, tracking devices) in the operating environment without the need to set up additional calibration assistance devices. Therefore, the extrinsic calibration parameters can be correctly generated, the accuracy of the device execution operation is improved, and the user's service experience is enhanced.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting an application environment of the first embodiment;

FIG. 2 is a schematic view depicting a extrinsic calibration parameter generating device of the first embodiment;

FIG. 3 is a schematic view depicting an operating environment of some embodiment;

FIG. 4 is a schematic view depicting an operating environment of some embodiment;

FIG. 5 is a schematic view depicting an operating environment of some embodiment; and

FIG. 6 is a partial flowchart depicting an extrinsic calibration parameter generating method of the third embodiment.

### DETAILED DESCRIPTION

In the following description, an extrinsic calibration parameter generating device, system, and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

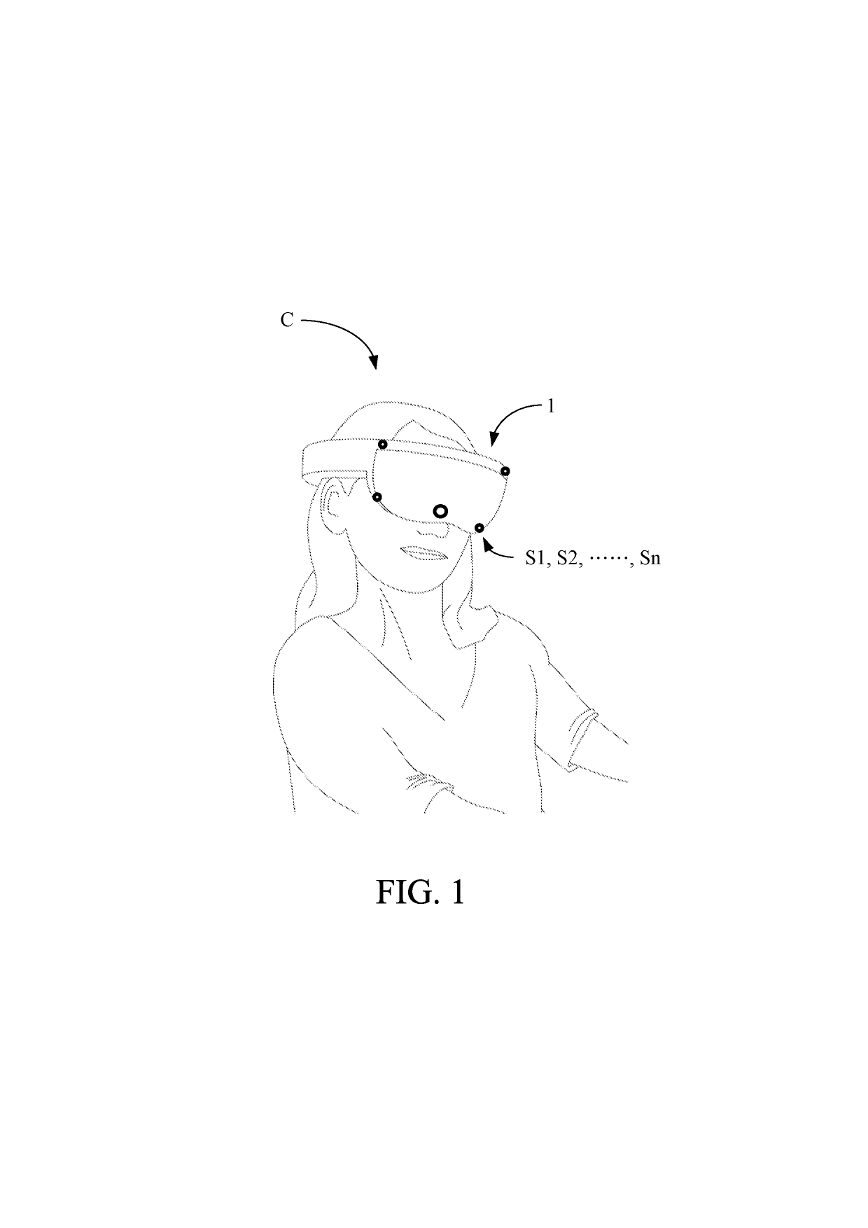

The applicable scenario of the present embodiment is first described, and its schematic diagram is depicted in FIG. 1. As shown in FIG. 1, in the application environment of the present disclosure, a user C may use an extrinsic calibration parameter generating device 1 (e.g., a head mounted display) including a plurality of sensors S1, S2, ..., Sn to perform operation.

It shall be appreciated that the extrinsic calibration parameter generating device 1 disclosed herein is not limited to the electronic device operated by the user C. The extrinsic calibration parameter generating device 1 can be any electronic device in the environment that needs to be calibrated (for example: a controller placed in the environment, a self-tracking device, or other user-operated device).

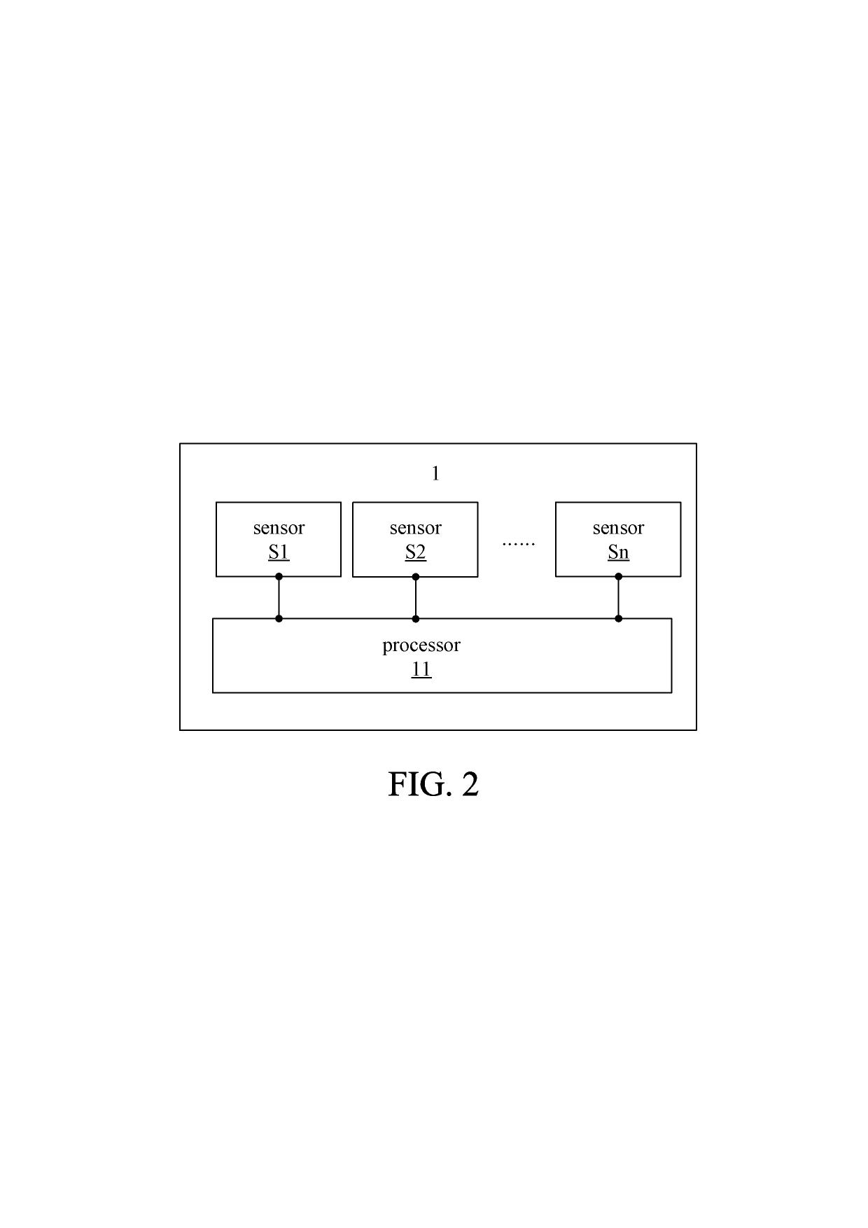

The first embodiment of the present disclosure is an extrinsic calibration parameter generating device 1 and a schematic view of which is depicted in FIG. 2. In the present embodiment, the extrinsic calibration parameter generating device 1 at least includes a plurality of sensors S1, S2, ..., Sn and a processor 11. The processor 11 is electrically connected to the sensors S1, S2, ..., Sn, wherein n is a positive integer.

It shall be appreciated that the processor 11 may be any of various processors, Central Processing Units (CPUs), microprocessors, digital signal processors or other computing apparatuses known to those of ordinary skill in the art. The sensors S1, S2, ..., Sn may be any devices having a spatial sensing function.

For example, the sensors S1, S2, ..., Sn may be a camera, a photodiode, an emitter/receiver, a structured light/laser, etc., which are sensing devices with depth resolution capabilities.

For example, the sensor may be an image capturer having an image capture function (e.g., a general camera or a depth camera lens) for generating a real-time image corresponding to a field of view (FOV).

For another example, the sensor may be composed of an emitter and a receiver, and generate corresponding observation data through spatial relationship parameters and emitting parameters (e.g., an emitting time, an emitting power, an emitting pattern).

In some embodiments, the extrinsic calibration parameter generating device 1 may comprise a sensor pair or a sensor array composed of some or all of the sensors S1, S2, ..., Sn. For example, each sensor pair may be a stereo camera composed of at least two cameras.

It shall be appreciated that the present disclosure does not limit the number of sensors included in the extrinsic calibration parameter generating device 1, as long as the extrinsic calibration parameter generating device 1 has two or more sensors (i.e., at least two sensors), the extrinsic calibration parameter corresponding to these sensors can be calibrated through the present disclosure.

In some embodiments, the extrinsic calibration parameter generating device 1 may be a head mounted display, which generates extrinsic calibration parameters to calibrate its own sensors. In some embodiments, the extrinsic calibration parameter generating device 1 may also be implemented by an electronic device having a plurality of sensors (e.g., a controller, a tracking device).

In addition, the sensors S1, S2, ..., Sn can be disposed at different positions of the extrinsic calibration parameter generating device 1 (e.g., the left and right sides of the head mounted display), and generate corresponding observation data at different observation angles (e.g., generate corresponding image frames with different image capture angles).

The operation of the present disclosure is briefly described first. In the present disclosure, the extrinsic calibration parameter generating device 1 can collect observation data of a plurality of sensors for at least one spatial point (e.g., corner point, feature point) in a physical space, and calculate the spatial position indicated by the observation data of each sensor (e.g., coordinates in a three-dimensional space). Based on the aforementioned operation of comparing the spatial positions, the calibration parameter generating device 1 can find a sensor (i.e., the sensor to be calibrated) with different calculation results from other sensors, and generate extrinsic calibration parameters based on the observation data generated by the sensor corresponding to the correct spatial position result. The following will explain the implementation details.

First, in the present embodiment, each of the sensors S1, S2, ..., Sn generates an observation data corresponding to a spatial point. Next, the processor 11 receives the observation data from the sensors S1, S2 , ..., Sn.

Next, in the present embodiment, the processor 11 calculates a spatial position of the spatial point indicated by each of the observation data based on the observation data of each of the sensors S1, S2, ..., Sn.

In some embodiments, the processor 11 can perform global optimization on the observation data of the same environment and the spatial map information created by the sensors S1, S2, ..., Sn to reversely infer the spatial position of the spatial point indicated by each observation data. Specifically, the processor 11 performs a global optimization operation corresponding to a simultaneous localization and mapping algorithm on the observation data to generate the spatial position corresponding to the spatial point indicated by each of the observation data.

Next, in the present embodiment, the processor 11 compares the spatial position indicated by each of the observation data to determine whether each of the observation data belongs to an outlier value or a normal value.

In some embodiments, the processor 11 compares the observation data of the sensors S1, S2, ..., Sn to cluster each of the observation data into a normal cluster or an outlier cluster. Next, the processor 11 determines whether each of the observation data belongs to the outlier value or the normal value based on the normal cluster or the outlier cluster.

In some embodiments, the observation data clustered into the normal cluster belong to the normal value, and the observation data clustered into the outlier cluster belong to the outlier value.

For example, the extrinsic calibration parameter generating device 1 includes five sensors S1, S2, S3, S4, and S5. After the processor 11 calculates the spatial position of the spatial point P indicated by each observation data, the spatial positions of the spatial point P indicated by four sensors S1, S2, S3, and S5 are all located at the three-dimensional coordinates (1, 1, 1), and the spatial position of the spatial point P indicated by one sensor S4 is located at the three-dimensional coordinates (1, 0, 1).

In the present example, the processor 11 determines that the observation data of the sensors S1, S2, S3, and S5 belong to the normal value, and the sensors S1, S2, S3, and S5 are clustered into the normal cluster. The processor 11 determines that the observation data of the sensor S4 belongs to the outlier value, and the sensor S4 is clustered into the outlier cluster.

Finally, in the present embodiment, in response to having observation data of a sensor (e.g., the first sensor referred to in some contents of the present disclosure) belonging to the outlier value, the processor 11 generates an extrinsic calibration parameter corresponding to the sensor to be calibrated (e.g., the first sensor) based on the observation data of each of the other sensors (e.g., the at least one second sensor referred to in some contents of the present disclosure), and the observation data of each of the sensors to be calibrated (e.g., the at least one second sensor) belongs to the normal value.

It shall be appreciated that the present disclosure can perform six-degree-of-freedom extrinsic parameter calibration based on extrinsic calibration parameters generated by sensors at other observation angles. Therefore, the present disclosure can solve the problem that only five degrees of freedom extrinsic correction can be performed when the deformation direction is parallel to the epipolar line (i.e., horizontal variation/scale cannot be calibrated).

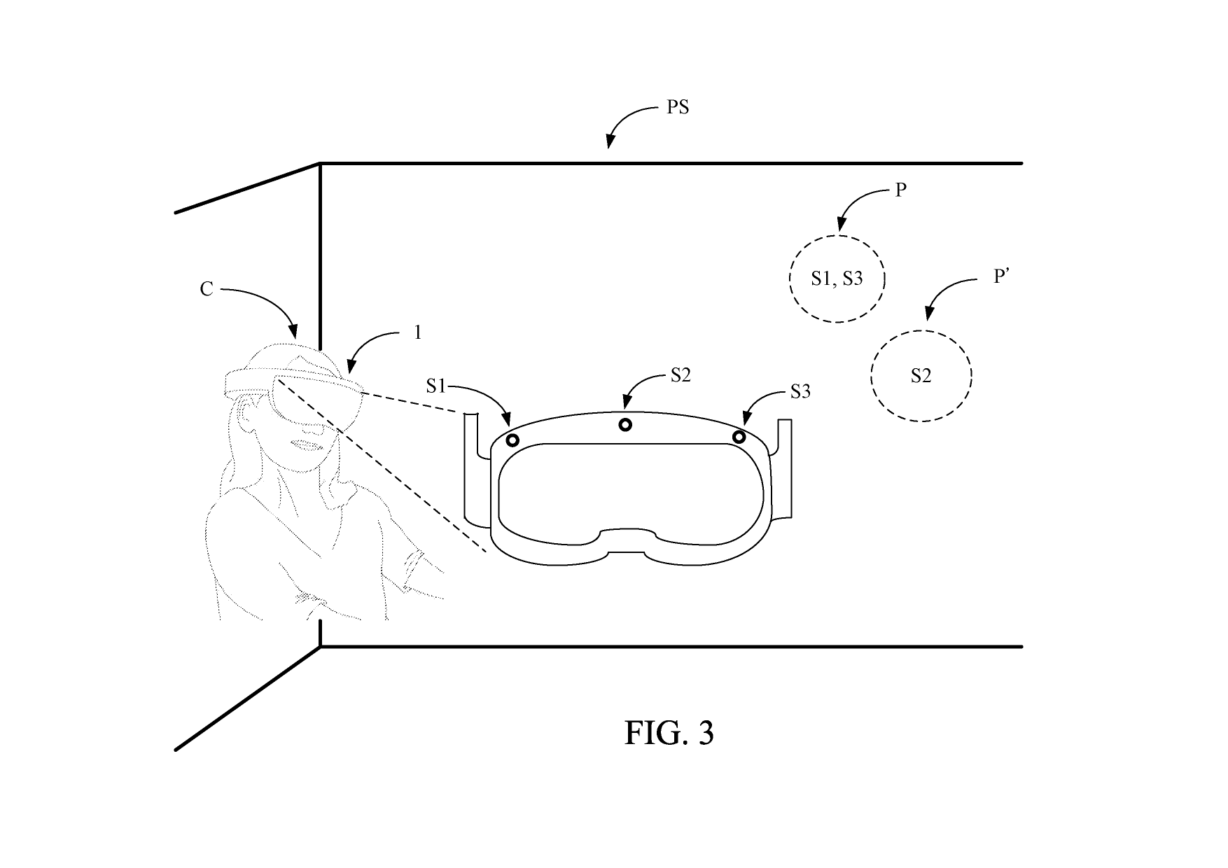

For easier understanding, please refer to FIG. 3. FIG. 3 is a schematic diagram illustrating a user C wearing the extrinsic calibration parameter generating device 1 in a physical space PS. The extrinsic calibration parameter generating device 1 includes three sensors S1, S2, and S3, all of which are active depth cameras. In the present example, the sensors S1, S2, and S3 generate observation data corresponding to a spatial point P, respectively. Next, the processor 11 calculates the spatial position of the spatial point P indicated by each of the observation data.

In the present example, the spatial positions of the spatial point P calculated by the processor 11 based on the observation data generated by the sensors S1 and S3 are consistent. The processor 11 calculates the spatial position of the spatial point P based on the observation data generated by the sensor S2, and the result indicates that the position has shifted to the spatial point P'. In the present example, the processor 11 determines that the sensor S2 is shifting, so the processor 11 generates extrinsic calibration parameters based on the observation data generated by the sensors S1 and S3 to calibrate the sensor S2.

In some embodiments, the sensors S1, S2, ..., Sn comprise at least one sensor pair, and the observation data generated by the at least one sensor pair comprises an image frame captured by the at least one sensor pair.

In some embodiments, the at least one sensor pair is a stereo camera pair consisting of a plurality of image capturers, and the observation data generated by the stereo camera pair comprise the image frame captured by the image capturers.

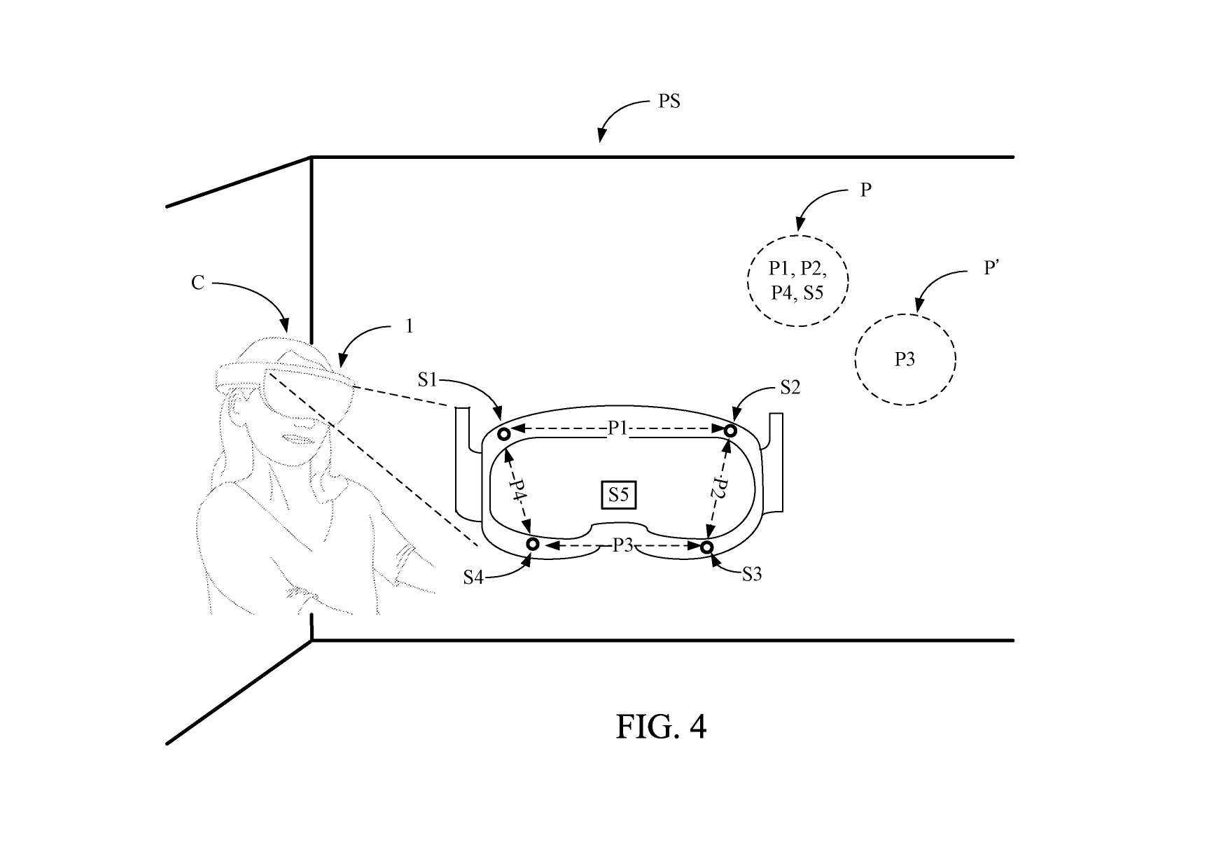

For easier understanding, please refer to FIG. 4. FIG. 4 is a schematic diagram illustrating a user C wearing the extrinsic calibration parameter generating device 1 in a physical space PS. In the present example, the extrinsic calibration parameter generating device 1 includes a sensor pair P1 composed of the sensors S1 and S2, a sensor pair P2 composed of the sensors S2 and S3, a sensor pair P3 composed of the sensors S3 and S4, a sensor pair P4 composed of the sensors S4 and S1, and a sensor S5 of an active depth camera.

In the present example, the sensor pair P1, the sensor pair P2, the sensor pair P3, the sensor pair P4, and the sensor S5 generate observation data corresponding to the spatial point P respectively. Next, the processor 11 calculates the spatial position of the spatial point P indicated by each of the observation data.

In the present example, the spatial positions of the spatial point P calculated by the processor 11 based on the observation data generated by the sensor pair P1, the sensor pair P2, the sensor pair P4, and the sensor S5 are consistent. The processor 11 calculates the spatial position of the spatial point P based on the observation data generated by the sensor S3, and the result indicates that the position has shifted to the spatial point P'. In the present example, the processor 11 determines that the sensor S3 is shifting, so the processor 11 generates extrinsic calibration parameters based on the observation data generated by the sensor pair P1, the sensor pair P2, the sensor pair P4, and the sensor S5 to calibrate the sensor S2.

In some embodiments, the sensors S1, S2, ..., Sn include an active depth camera (e.g., referred to as a first active depth camera or a second active depth camera in some contents of the present disclosure).

In some embodiments, the first active depth camera comprises a first emitter and a first receiver, and the observation data generated by the first active depth camera comprises a spatial relationship parameter captured by the first emitter and the first receiver. For example: depth sensing technology using Time of Flight (TOF).

In some embodiments, the second active depth camera comprises a second emitter and a second receiver, and the observation data generated by the second active depth camera comprises a structured light pattern and a light coding generated by the second emitter and the second receiver. For example: depth sensing technology using structured light.

It shall be appreciated that the combinations exemplified in this disclosure are only for convenience of description, and the present disclosure does not limit the combinations of sensors. The sensors in the extrinsic calibration parameter generating device 1 can be arbitrarily combined or matched through the aforementioned first active depth camera, the second active depth camera, or the sensor pair, depending on the actual application requirements of the device itself.

In some embodiments, the processor 11 adjusts at least one of an emitting time, an emitting power, and an emitting pattern, or a combination thereof corresponding to the first sensor based on the extrinsic calibration parameter. For example, when the first sensor is an active depth camera, the processor 11 may adjust an emitting time and an emitting power of the first sensor.

In some embodiments, the processor 11 calibrates a positioning information corresponding to the first sensor based on the extrinsic calibration parameter.

The extrinsic calibration parameter generating device 1 provided by the present disclosure collects observation data corresponding to a spatial point generated by multiple sensors. Next, the observation data of the same environment from the sensors are compared to determine which observation data generated by the sensor is an outlier value (e.g., position offset may occur). Then, the extrinsic calibration parameters corresponding to the outlier sensor can be generated through the observation data generated by other non-outlier sensors in the environment, and the outlier sensor can be calibrated based on the extrinsic calibration parameters until the observation data generated by the outlier sensor is consistent with that of other sensors. In addition, the extrinsic calibration parameter generating device 1 provided by the present disclosure can be assisted in calibration by other electronic devices (e.g., controllers, tracking devices) in the operating environment without the need to set up additional calibration assistance devices. Therefore, the extrinsic calibration parameters can be correctly generated, the accuracy of the device execution operation is improved, and the user's service experience is enhanced.

In some embodiments, the extrinsic calibration parameter generating technology disclosed herein can be extended to be performed between a plurality of electronic devices in an environment (i.e., an external calibration parameter generation system), which will be described in detail below.

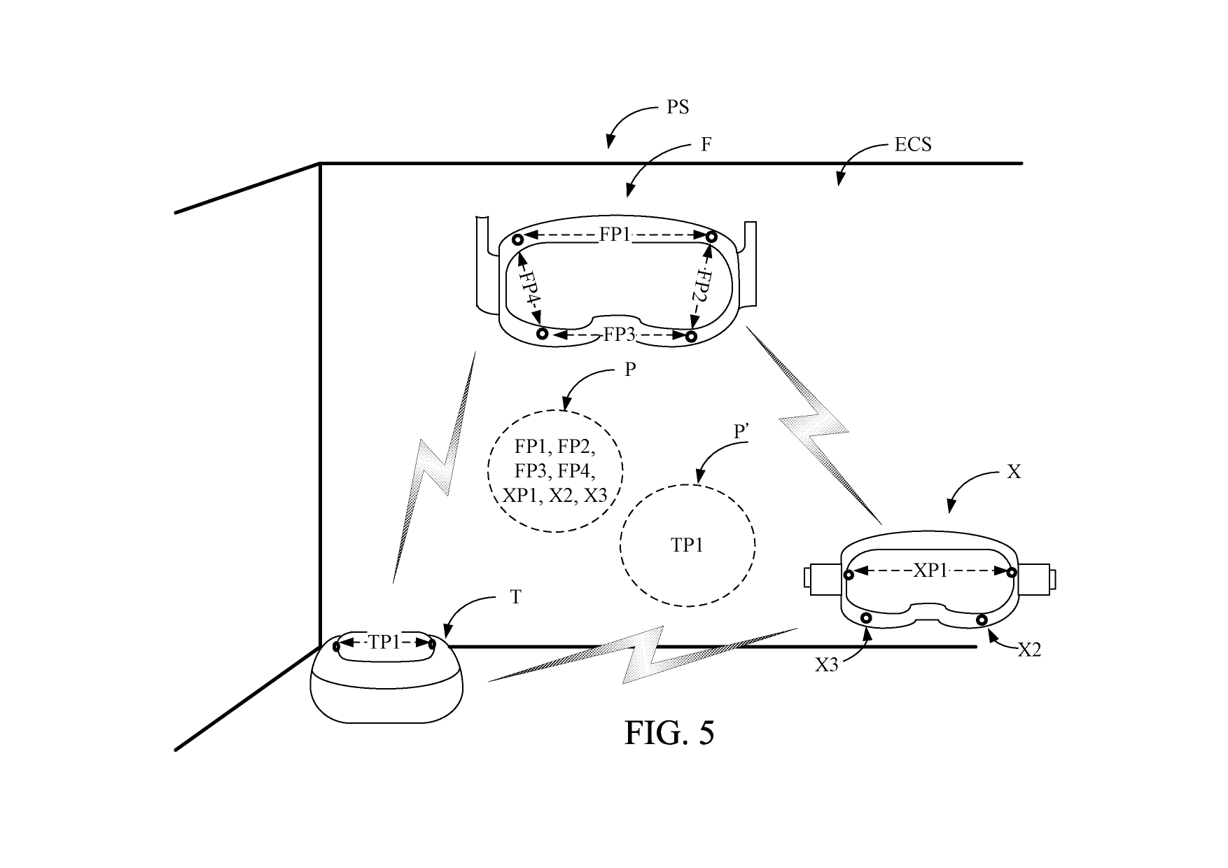

The second embodiment of the present disclosure is an extrinsic calibration parameter generating system ECS, a schematic diagram of its structure is depicted in FIG. 5. In the present embodiment, the extrinsic calibration parameter generating system ECS may comprise a plurality of electronic devices and a processing device (for example, any electronic device with computing capability in the system can be used as the processing device), and the processing device is communicatively connected to the electronic devices. Each of the electronic devices comprises at least one sensor, and each of the at least one sensor generates an observation data corresponding to a spatial point.

In the present embodiment, the processing device receives the observation data from each of the electronic devices. Next, the processing device calculates a spatial position of the spatial point indicated by each of the observation data based on the observation data.

Next, the processing device compares the spatial position indicated by each of the observation data to determine whether each of the observation data is an outlier value or a normal value.

Finally, in response to the observation data corresponding to a first sensor belonging to the outlier value, the processing device generates an extrinsic calibration parameter corresponding to the first sensor based on the observation data of each of at least one second sensor, wherein the observation data of each of the at least one second sensor belongs to the normal value.

In some embodiments, the first sensor is disposed in a first electronic device, the at least one second sensor is disposed in a second electronic device, and the first electronic device is different from the second electronic device.

In addition to the aforesaid steps, the second embodiment can also execute all the operations and steps of the extrinsic calibration parameter generating device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

For easier understanding, please refer to FIG. 5. FIG. 5 is a schematic diagram illustrating an extrinsic calibration parameter generating system ECS composed of a plurality of electronic devices and a processing device. In the present example, the extrinsic calibration parameter generating system ECS includes an electronic device F, an electronic device X, and an electronic device T.

In the present example, each electronic device can be used by a different user. The electronic device F includes a sensor pair FP1, a sensor pair FP2, a sensor pair FP3, and a sensor pair FP4. The electronic device X includes a sensor pair XP1, and the sensors X3 and X2 of an active depth camera. The electronic device T includes a sensor pair TP1. For the sake of convenience, in this example, the electronic device T is used as the processing device.

In the present example, the sensor pair FP1, the sensor pair FP2, the sensor pair FP3, and the sensor pair FP4 of the electronic device F respectively generate observation data corresponding to the spatial point P. The sensor pair XP1 and the sensors X3 and X2 of the active depth camera of the electronic device X generate observation data corresponding to the spatial point P respectively. The sensor pair TP1 of the electronic device T generates observation data corresponding to the spatial point P.

Next, the electronic device T receives the observation data and calculates the spatial position of the spatial point P indicated by each of the observation data.

In the present example, the spatial positions of the spatial point P calculated by the electronic device T based on the observation data generated by the sensor pair FP1-FP4, the sensor pair XP1, and the sensors X3 and X2 are consistent. The electronic device T calculates the spatial position of the spatial point P based on the observation data generated by the sensor pair TP1, and the result indicates that the position has shifted to the spatial point P'. In the present example, the electronic device T determines that the sensor pair TP1 is shifting, so the electronic device T generates extrinsic calibration parameters based on the observation data generated by some or all of the sensor pairs FP1-FP4, the sensor pair XP1, and the sensors X3 and X2 to calibrate the sensor pair TP1.

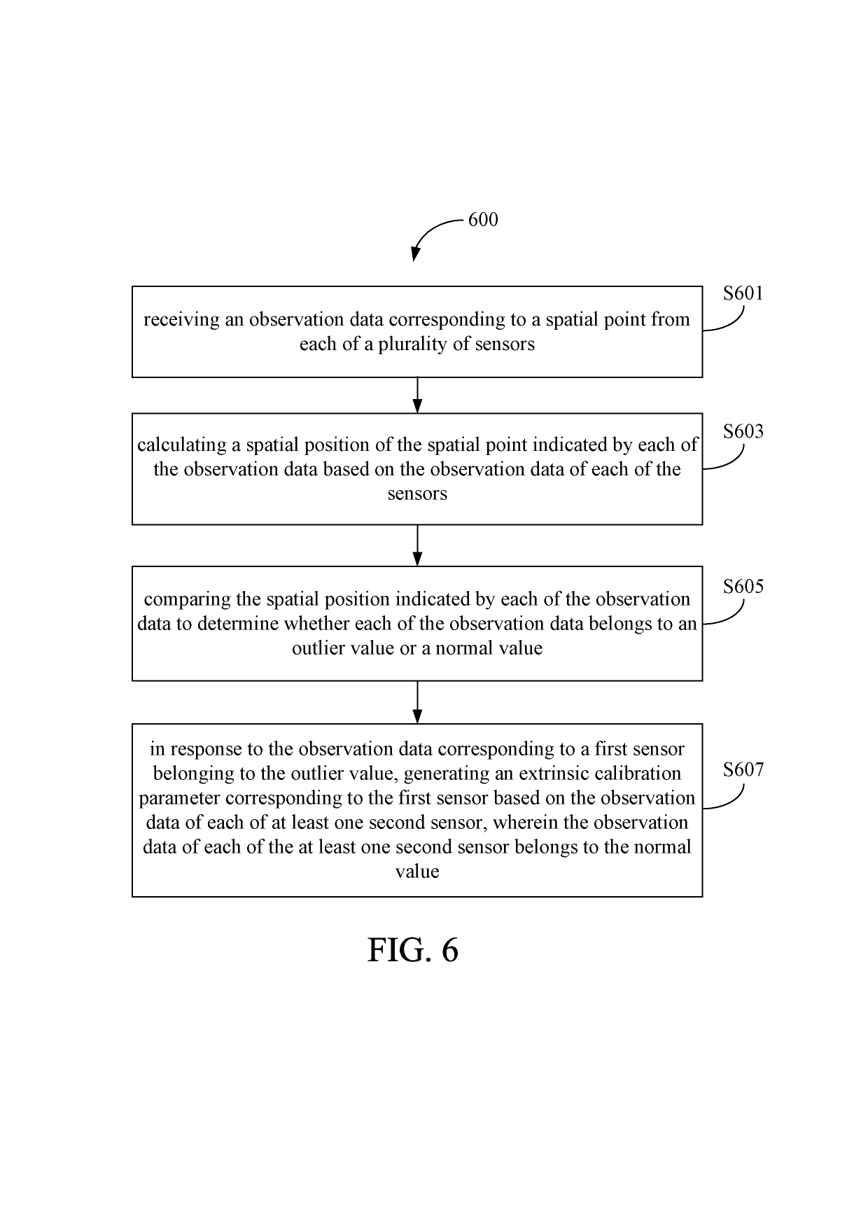

A third embodiment of the present disclosure is an extrinsic calibration parameter generating method and a flowchart thereof is depicted in FIG. 6. The extrinsic calibration parameter generating method 600 is adapted for an electronic apparatus (e.g., the extrinsic calibration parameter generating device 1 of the first embodiment or the extrinsic calibration parameter generating system ECS). The extrinsic calibration parameter generating method 600 generates an extrinsic calibration parameter through the steps S601 to S607.

First, in the step S601, the electronic apparatus receives an observation data corresponding to a spatial point from each of a plurality of sensors.

In the step S603, the electronic apparatus calculates a spatial position of the spatial point indicated by each of the observation data based on the observation data of each of the sensors.

Next, in the step S605, the electronic apparatus compares the spatial position indicated by each of the observation data to determine whether each of the observation data belongs to an outlier value or a normal value.

Finally, in the step S607, in response to the observation data corresponding to a first sensor belonging to the outlier value, the electronic apparatus generates an extrinsic calibration parameter corresponding to the first sensor based on the observation data of each of at least one second sensor, wherein the observation data of each of the at least one second sensor belongs to the normal value.

In some embodiments, wherein the step of determining whether each of the observation data belongs to the outlier value or the normal value comprises the following steps: comparing the observation data of the sensors to cluster each of the observation data into a normal cluster or an outlier cluster; and determining whether each of the observation data belongs to the outlier value or the normal value based on the normal cluster or the outlier cluster.

In some embodiments, the sensors comprise a first active depth camera, the first active depth camera comprises a first emitter and a first receiver, and the observation data generated by the first active depth camera comprises a spatial relationship parameter captured by the first emitter and the first receiver.

In some embodiments, the sensors comprise a second active depth camera, the second active depth camera comprises a second emitter and a second receiver, and the observation data generated by the second active depth camera comprises a structured light pattern and a light coding generated by the second emitter and the second receiver.

In some embodiments, the sensors comprise at least one sensor pair, and the observation data generated by the at least one sensor pair comprises an image frame captured by the at least one sensor pair.

In some embodiments, the at least one sensor pair is a stereo camera pair consisting of a plurality of image capturers, and the observation data generated by the stereo camera pair comprise the image frame captured by the image capturers.

In some embodiments, the step of calculating the spatial position of the spatial point indicated by each of the observation data comprises the following steps: performing a global optimization operation corresponding to a simultaneous localization and mapping algorithm on the observation data to generate the spatial position corresponding to the spatial point indicated by each of the observation data.

In some embodiments, the extrinsic calibration parameter generating method further comprises the following steps: adjusting at least one of an emitting time, an emitting power, an emitting pattern, or a combination thereof corresponding to the first sensor based on the extrinsic calibration parameter.

In some embodiments, the first sensor is disposed in a first electronic device, the at least one second sensor is disposed in a second electronic device, and the first electronic device is different from the second electronic device.

In some embodiments, the extrinsic calibration parameter generating method 600 further comprises the following steps: calibrating a positioning information corresponding to the first sensor based on the extrinsic calibration parameter.

In addition to the aforesaid steps, the third embodiment can also execute all the operations and steps of the extrinsic calibration parameter generating device 1 and the extrinsic calibration parameter generating system ECS set forth in the first embodiment and the second embodiment, have the same functions, and deliver the same technical effects as the first embodiment and the second embodiment. How the third embodiment executes these operations and steps, has the same functions, and delivers the same technical effects will be readily appreciated by those of ordinary skill in the art based on the explanation of the first embodiment and the second embodiment. Therefore, the details will not be repeated herein.

It shall be appreciated that in the specification and the claims of the present disclosure, some words (e.g., sensor, electronic device, active depth camera, emitter, receiver) are preceded by terms such as “first”, or “second”, and these terms of “first”, or “second” are only used to distinguish these different words. For example, the “first” and “second” sensor are only used to indicate the sensor used in different operations.

According to the above descriptions, the extrinsic calibration parameter generating technology (at least including the device, the system, and the method) provided by the present disclosure collects observation data corresponding to a spatial point generated by multiple sensors. Next, the observation data of the same environment from the sensors are compared to determine which observation data generated by the sensor is an outlier value (e.g., position offset may occur). Then, the extrinsic calibration parameters corresponding to the outlier sensor can be generated through the observation data generated by other non-outlier sensors in the environment, and the outlier sensor can be calibrated based on the extrinsic calibration parameters until the observation data generated by the outlier sensor is consistent with that of other sensors. In addition, the extrinsic calibration parameter generation technology provided by the present disclosure can be assisted in calibration by other electronic devices (e.g., controllers, tracking devices) in the operating environment without the need to set up additional calibration assistance devices. Therefore, the extrinsic calibration parameters can be correctly generated, the accuracy of the device execution operation is improved, and the user's service experience is enhanced.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

WHAT IS CLAIMED IS:

1. An extrinsic calibration parameter generating device, comprising:
a plurality of sensors; and
a processor, being electrically connected to the plurality of sensors;
wherein the extrinsic calibration parameter generating device is configured to perform operations comprising:
generating, by each of the plurality of sensors, an observation data corresponding to a spatial point;
calculating, by the processor, a spatial position of the spatial point indicated by each of the observation data based on the observation data of each of the sensors;
comparing, by the processor, the spatial position indicated by each of the observation data to determine whether each of the observation data belongs to an outlier value or a normal value; and
in response to the observation data corresponding to a first sensor belonging to the outlier value, generating, by the processor, an extrinsic calibration parameter corresponding to the first sensor based on the observation data of each of at least one second sensor, wherein the observation data of each of the at least one second sensor belongs to the normal value.

2. The extrinsic calibration parameter generating device of claim 1, wherein the operation of determining whether each of the observation data belongs to the outlier value or the normal value comprises the following operations:
comparing the observation data of the sensors to cluster each of the observation data into a normal cluster or an outlier cluster; and
determining whether each of the observation data belongs to the outlier value or the normal value based on the normal cluster or the outlier cluster.

3. The extrinsic calibration parameter generating device of claim 2, wherein the observation data clustered into the normal cluster belong to the normal value, and the observation data clustered into the outlier cluster belong to the outlier value.

4. The extrinsic calibration parameter generating device of claim 1, wherein the sensors comprise a first active depth camera, the first active depth camera comprises a first emitter and a first receiver, and the observation data generated by the first active depth camera comprises a spatial relationship parameter captured by the first emitter and the first receiver.

5. The extrinsic calibration parameter generating device of claim 1, wherein the sensors comprise a second active depth camera, the second active depth camera comprises a second emitter and a second receiver, and the observation data generated by the second active depth camera comprises a structured light pattern and a light coding generated by the second emitter and the second receiver.

6. The extrinsic calibration parameter generating device of claim 1, wherein the sensors comprise at least one sensor pair, and the observation data generated by the at least one sensor pair comprises an image frame captured by the at least one sensor pair.

7. The extrinsic calibration parameter generating device of claim 6, wherein the at least one sensor pair is a stereo camera pair consisting of a plurality of image capturers, and the observation data generated by the stereo camera pair comprise the image frame captured by the image capturers.

8. The extrinsic calibration parameter generating device of claim 1, wherein the operation of calculating the spatial position of the spatial point indicated by each of the observation data comprises the following operations:
performing a global optimization operation corresponding to a simultaneous localization and mapping algorithm on the observation data to generate the spatial position corresponding to the spatial point indicated by each of the observation data.

9. The extrinsic calibration parameter generating device of claim 1, wherein the processor further performs the following operations:
adjusting at least one of an emitting time, an emitting power, an emitting pattern, or a combination thereof corresponding to the first sensor based on the extrinsic calibration parameter.

10. The extrinsic calibration parameter generating device of claim 1, wherein the processor further performs the following operations:
calibrating a positioning information corresponding to the first sensor based on the extrinsic calibration parameter.

11. A extrinsic calibration parameter generating method, being adapted for use in an electronic device, wherein the extrinsic calibration parameter generating method comprises:
receiving an observation data corresponding to a spatial point from each of a plurality of sensors;
calculating a spatial position of the spatial point indicated by each of the observation data based on the observation data of each of the sensors;
comparing the spatial position indicated by each of the observation data to determine whether each of the observation data belongs to an outlier value or a normal value; and
in response to the observation data corresponding to a first sensor belonging to the outlier value, generating an extrinsic calibration parameter corresponding to the first sensor based on the observation data of each of at least one second sensor, wherein the observation data of each of the at least one second sensor belongs to the normal value.

12. The extrinsic calibration parameter generating method of claim 11, wherein the step of determining whether each of the observation data belongs to the outlier value or the normal value comprises the following steps:
comparing the observation data of the sensors to cluster each of the observation data into a normal cluster or an outlier cluster; and
determining whether each of the observation data belongs to the outlier value or the normal value based on the normal cluster or the outlier cluster.

13. The extrinsic calibration parameter generating method of claim 11, wherein the sensors comprise a first active depth camera, the first active depth camera comprises a first emitter and a first receiver, and the observation data generated by the first active depth camera comprises a spatial relationship parameter captured by the first emitter and the first receiver.

14. The extrinsic calibration parameter generating method of claim 11, wherein the sensors comprise a second active depth camera, the second active depth camera comprises a second emitter and a second receiver, and the observation data generated by the second active depth camera comprises a structured light pattern and a light coding generated by the second emitter and the second receiver.

15. The extrinsic calibration parameter generating method of claim 11, wherein the sensors comprise at least one sensor pair, and the observation data generated by the at least one sensor pair comprises an image frame captured by the at least one sensor pair.

16. The extrinsic calibration parameter generating method of claim 15, wherein the at least one sensor pair is a stereo camera pair consisting of a plurality of image capturers, and the observation data generated by the stereo camera pair comprise the image frame captured by the image capturers.

17. The extrinsic calibration parameter generating method of claim 11, wherein the step of calculating the spatial position of the spatial point indicated by each of the observation data comprises the following steps:
performing a global optimization operation corresponding to a simultaneous localization and mapping algorithm on the observation data to generate the spatial position corresponding to the spatial point indicated by each of the observation data.

18. The extrinsic calibration parameter generating method of claim 11, wherein the extrinsic calibration parameter generating method further comprises the following steps:
adjusting at least one of an emitting time, an emitting power, an emitting pattern, or a combination thereof corresponding to the first sensor based on the extrinsic calibration parameter.

19. The extrinsic calibration parameter generating method of claim 11, wherein the first sensor is disposed in a first electronic device, the at least one second sensor is disposed in a second electronic device, and the first electronic device is different from the second electronic device.

20. An extrinsic calibration parameter generating system, comprising:
a plurality of electronic devices, wherein each of the electronic devices comprises at least one sensor, and each of the at least one sensor generates an observation data corresponding to a spatial point; and
a processing device, being communicatively connected to the electronic devices;
wherein the extrinsic calibration parameter generating system is configured to perform operations comprising:
receiving, by the processing device, the observation data from each of the electronic devices;
calculating, by the processing device based on the observation data, a spatial position of the spatial point indicated by each of the observation data;
comparing, by the processing device, the spatial position indicated by each of the observation data to determine whether each of the observation data belongs to an outlier value or a normal value; and
in response to the observation data corresponding to a first sensor belonging to the outlier value, generating, by the processing device, an extrinsic calibration parameter corresponding to the first sensor based on the observation data of each of at least one second sensor, wherein the observation data of each of the at least one second sensor belongs to the normal value.
